(19) United States
(12) Patent Application Publication
(10) Pub. No.: US 2004/0260770 A1
(43) Pub. Date: Dec. 23, 2004

(54) Communication method for business

(76) Inventors: Bruce Medlin, Palm Harbor, FL (US); Sheldon Livington, Largo, FL (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/862,644

(22) Filed: Jun. 7, 2004

Related U.S. Application Data
(60) Provisional application No. 60/476,700, filed on Jun. 6, 2003.

(51) Int. Cl. G06F 15/16

(52) U.S. Cl. 709/204

(57) ABSTRACT

The present invention provides a method for businesses to conduct business communications over a private network or the Internet. The method allows businesses to notify business personnel via email that when they are available there is updated business communications or questions to be answered. Business partners are permitted to log directly into the at least one virtual chat room where they are provided a user interface in the form of a split screen. The split screen interface includes a first portion that allows business partners to access stored business information or the Internet. The split screen interface also includes a second portion that allows group members to conduct business communications and/or answer questions in a business structured virtual environment, while permitting communications to be stored in a business format that is retrieveable for future use.

### RELATED APPLICATIONS

The present application claims the benefit of U.S. Provisional Application Ser. No. 60/476,700 having a filing date of June 6^{th}, 2003.

### FIELD OF THE INVENTION

The present invention relates to communication methods that utilize the Internet. More particularly, the present invention relates to a communication method that allows business personnel to conduct communications in predetermined virtual chat rooms while simultaneously having the ability to access stored business information and the Internet.

### BACKGROUND OF THE INVENTION

It is appreciated that all business require efficient and reliable methods of communication such that information relative to business management, business strategies, and internal communication amongst business personnel is organized in a business fashion for maintaining and promoting growth of the business. Many businesses rely heavily on programmers and network administrators to ensure that the many business needs are met with regard to information management and distribution. Conventional methods of facilitating business communications are provided at a substantial cost to many businesses and annual budgets must be set aside for frequent training and upgrading of information technology personnel and equipment. Accordingly, there is a need for a method that allows businesses to conduct business communications amongst business personnel and/or clients that can be done reliably and efficiently and provided at a cost savings relative to conventional methods for facilitating such communications.

### SUMMARY OF THE INVENTION

The present invention provides a method for businesses to communicate with their employees, associates and business partners via a private computer network or the Internet. The method comprises a plurality of steps wherein a user first logs onto a previously created service provider website which facilitates the creation, maintenance and usage of one or more virtual chat rooms to be described hereinafter. After creation of the one or more virtual chat rooms, a room administrator is allowed to designate group members that will have access to one or more of the virtual chat rooms. Hence, access privileges to chat rooms that are afforded to group members are controlled by the administrator.

After login into a virtual chat room, the group member is provided with an interface in the form of a split screen. A first portion of the split screen provides group members Internet access, access to business information and access to other rooms in which they have privileges. A second portion of the split screen provides for display and access to business communications being conducted in the virtual chat room. Hence, group members are allowed to selectively access the Internet while simultaneously participating in business communications while in the virtual chat room.

Next, business communications are further facilitated by providing the designated group members access to stored business information that can be viewed in the first portion of the split screen while simultaneously participating in business communications in the second portion of the split screen.

The business communications method of the present invention continues by automatically notifying via email a portion of the designated group members not participating in business communications in the one or more virtual chat rooms that business communications are being conducted in the one or more virtual chat rooms. The present invention provides an advantage in providing businesses an alternative method of facilitating and conducting business communications amongst business personnel wherein the method reduces the need for information technology specialists, application software and equipment through the use of the Internet and a customizable virtual environment.

### BRIEF DESCRIPTION OF THE DRAWINGS

A better understanding of the present invention will be had upon reference to the following detailed description when read in conjunction with the accompanying drawings in which like parts are given like reference numerals and wherein:

FIG. 1 illustrates a process flow diagram of the communication method for business as according to the invention;

FIG. 2 illustrates a diagrammatic view of the communication method for business exemplifying a scheme for group member access to one or more virtual chat rooms as according to the invention;

FIG. 3 illustrates a user interface in the form of a split screen as according to the invention;

FIG. 4 illustrates the user interface of FIG. 3 including a display of the virtual chat room(s) accessible by the designated group member as according to the invention;

FIG. 5 illustrates the user interface of FIG. 3 wherein stored information is displayed for review by the designated group member as according to the invention; and

FIG. 6 illustrates an exemplary embodiment of email message that is automatically sent to a group member not participating in chat room communications as notification that business communications are being conducted in the virtual chat room as according to the invention.

### DETAILED DESCRIPTION OF THE INVENTION

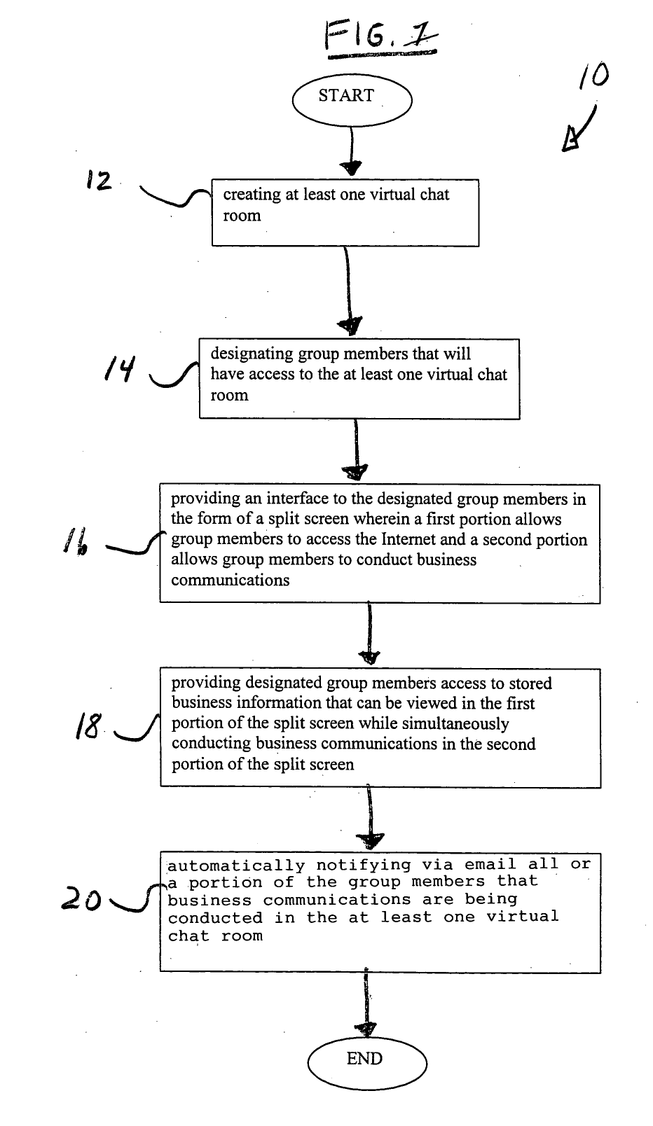

The present invention provides a method for businesses to communicate with their employees, associates and business partners via a private computer network or the Internet. The method includes a plurality of steps as illustrated in the process diagram 10 in FIG. 1. A user first logs onto a previously created service provider website which facilitates the creation of at least one virtual chat room at 12. The communication method for business advances from block 12 to block 14. At 14, a plurality of business personnel are designated as group members that will have access to the at least one virtual chat room created at 12. If multiple virtual chat rooms are created, e.g. Rooms A-D, then each room will have designated group members, e.g. Groups A-D, respectively. Individual group members may be allowed access to one or more of the virtual chat rooms. An administrator has the responsibility for creating the at least one virtual room in a chat area that may contain multiple virtual chat rooms. The administrator is also responsible for designating group members that will have access to each room created, and defining which rights/privileges each group member will have relative to other members within the group with regard to each virtual chat room. The chat area may have one or several administrators and administrators may also be group members. An administrator will be responsible for managing the virtual chat area, chat room features and group member access.

When an administrator logs onto the service provider website, he or she is provided a link to a system tool whereby he or she is allowed to add, edit or delete rooms, groups and/or group members from groups. Additional features allow the administrator to define the room access rights/privileges of group members as well as a means of viewing other administrative statistics and information. Only administrators are provided access to this link as the link can't be seen by the other group members after logging into a virtual chat room. After creation of the at least one virtual chat room and the designation of group members, the method of communication for business advances from block 14 to block 16.

At block 16, group members are permitted to log directly into the at least one virtual chat room where they are provided a user interface in the form of a split screen. The split screen interface includes a first portion that allows group members to access the Internet. The split screen interface also includes a second portion that allows group members to conduct business communications.

Administrators are required to input personal identification and other information as necessary when creating a member profile. This information is then submitted electronically to the service provider for processing such that the new member may be provided access/authentication information needed to access the at least one virtual chat room environment.

After obtaining a password, a member is permitted to log into the at least one virtual chat room by entering the password and a user ID provided by the service provider. The member ID may be the new member's e-mail address, but other identifiers may be used which illustratively include the user's name, initials, address, phone number, birthday or the like.

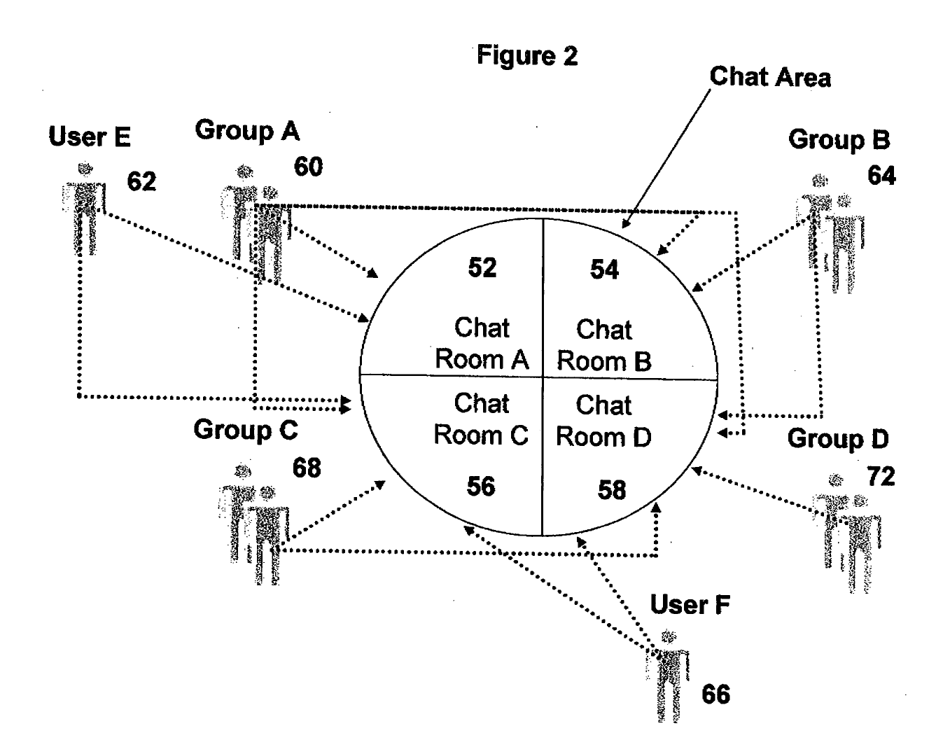

After logging in, members are provided a list of the rooms that they have access to as group members and/or administrators. The general concept of the present invention is that the administrator will create the virtual chat rooms and then designates the group members who will have access to one or more of the virtual chat rooms created. As best illustrated in the plan view of FIG. 2, virtual chat rooms (52, 54, 56, 58) are created at the service provider website 50 by administrators. Administrators are responsible for designating business personnel as group members (60, 64, 68, 72) that will have access to the virtual chat room they created. As shown, Group A members 60 are provided access to virtual chat rooms 52, 54, 56 and 58 (Rooms A, B, C and D). Group B members 64 are provided access to virtual chat rooms 54 and 58 (Rooms B and D). Group D members 72 are only provided access to virtual chat room 58 (Room D). Administrators may designate room access on both a user and group level (See FIG. 2).

Preferably, the group members 60, 64, 68, 72 are comprised of business partners, associates, employees, and the like whereby business communications can be carried effectively and efficiently via the method of communication for business as according to the invention.

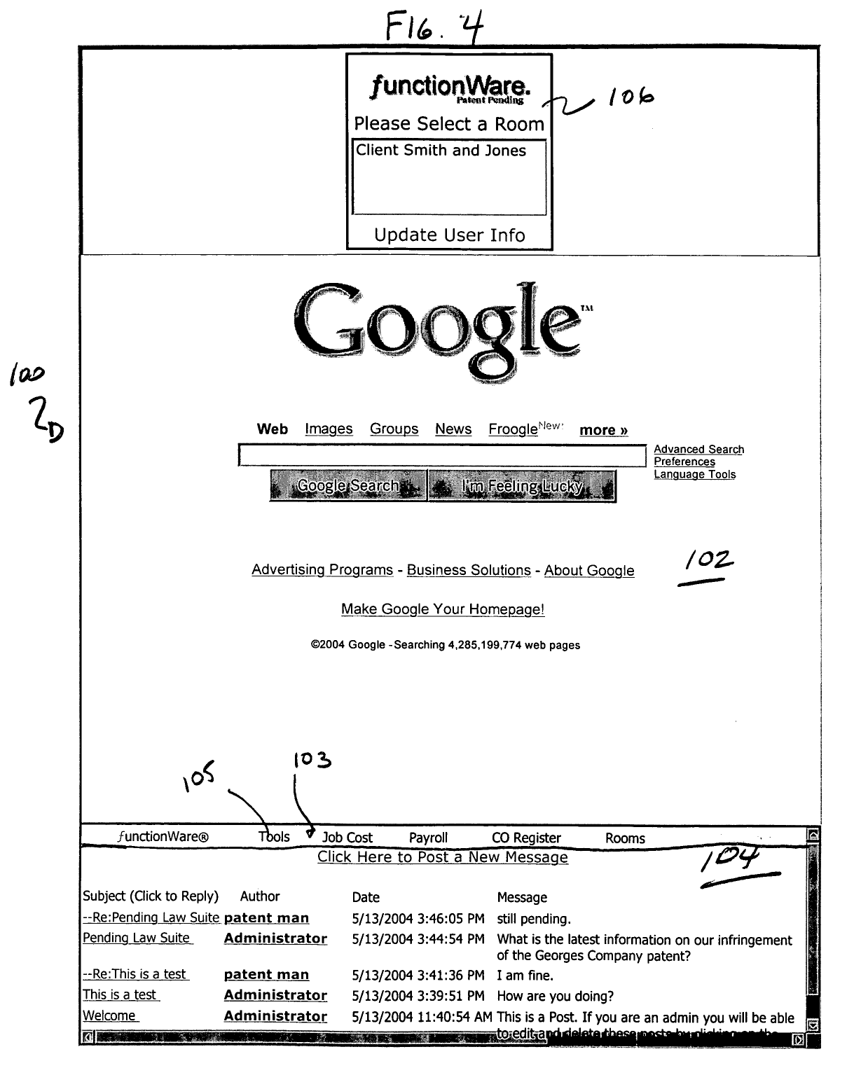

If group members are permitted access to more than one room, then these group members may switch between virtual chat rooms as desired. This is accomplished by simply selecting the desired virtual chat room from a list of virtual rooms made available to the group member (See 106 at FIG. 4). Group members will only have access to virtual chat rooms that appear in the list of virtual chat rooms 106 that they can see after logging into the virtual chat room environment.

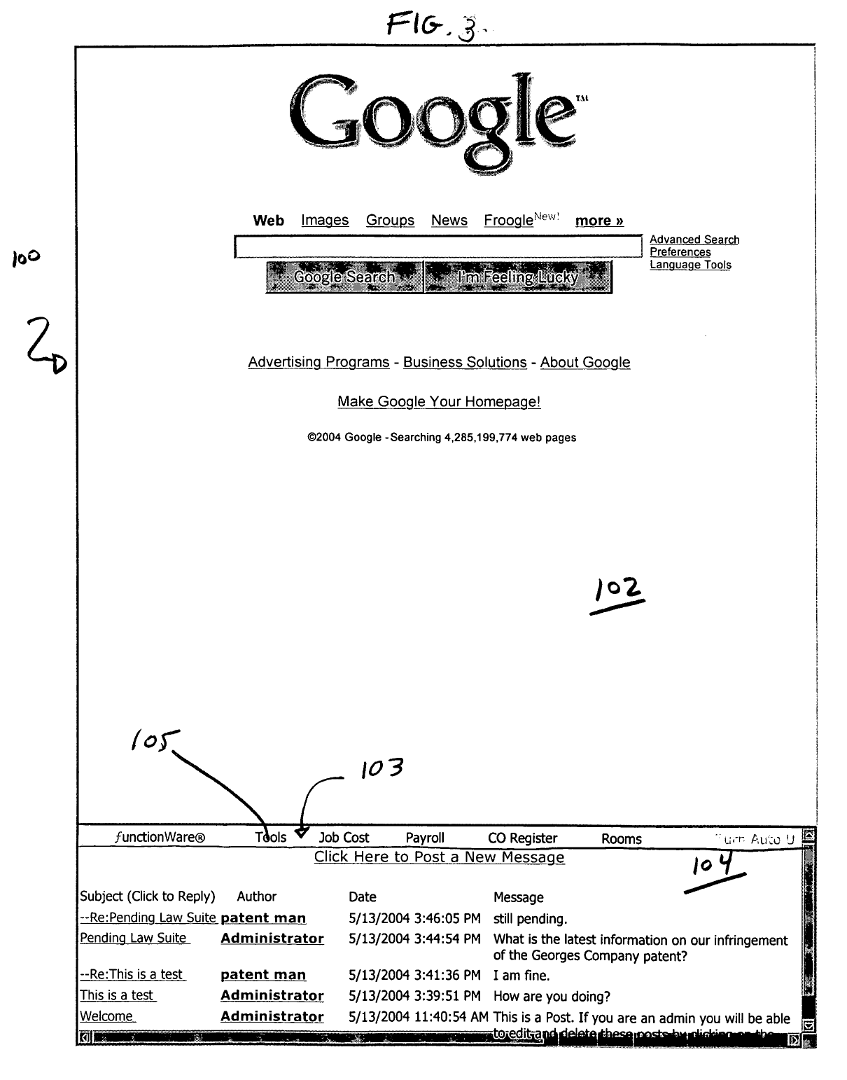

Once a group member has selected a virtual chat room from the list 106, a user interface 100 appears which is preferably split into at least two portions (102, 104 at FIG. 3). Although the split screen 100 configuration of FIG. 3 is preferred, it is appreciated that other screen configurations may be utilized without exceeding the scope of the invention.

Referring to FIG. 3-5, a menu bar 103 is provided that includes a tools menu 105. The tools menu 105 when clicked opens up window that allows group members to surf the Internet in the first portion 102 of the split screen 100 while keeping their virtual chat room at the second portion 104 of the split screen 100. Referring again to FIG. 1, the method of communication for business advances from block 16 to block 18.

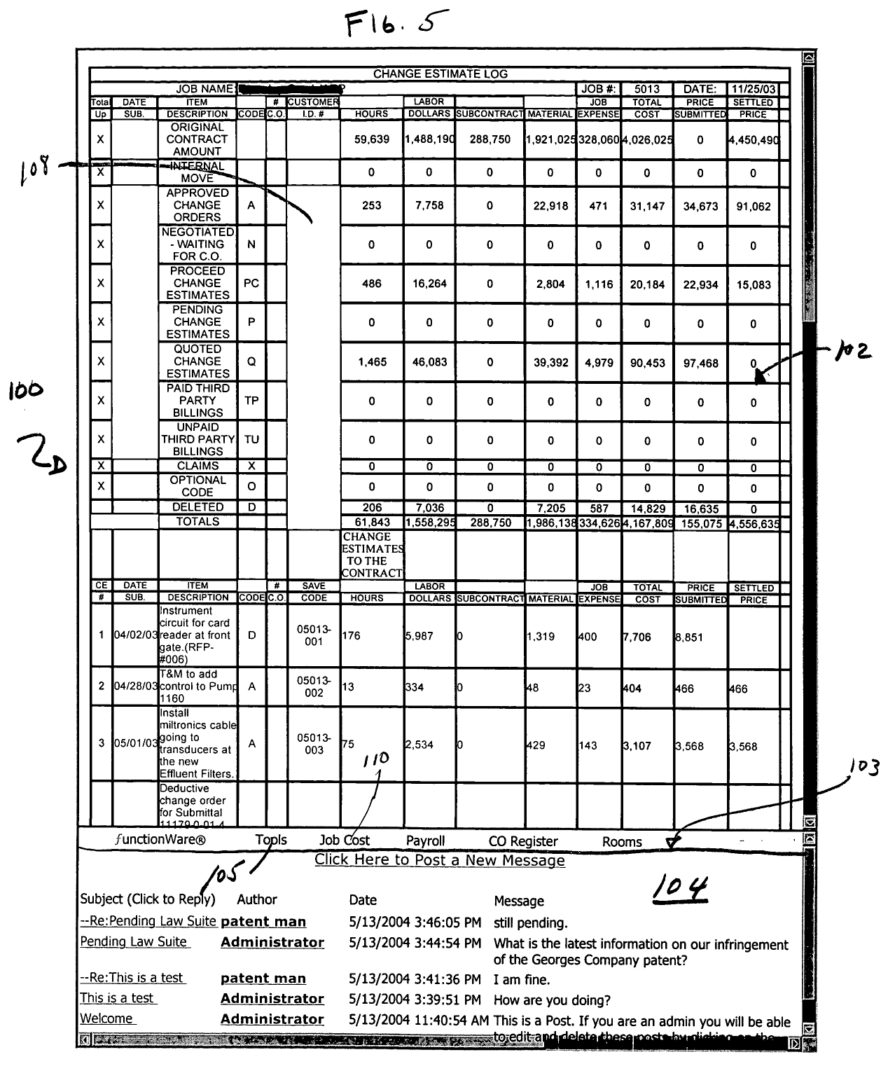

At block 18, the group members are provided access to stored business information or other documents. As best illustrated in FIG. 5, group members may choose to view job cost 108 data which would appear in the first portion 102 of the split screen when the job cost menu button 110 is clicked. It is appreciated that other business information or reports may also be viewed in this fashion while participating in chat room communications. Such information and/or reports may illustratively include proposals, promotional ads, graphic images, marketing strategies, program schedules, test results, lab reports, contracts and/or other important documents relative to the business. A group member may also post private messages that can be seen only by certain members within the group as designated by the user. When the member selects which other members should be notified of a post, the member might additionally indicate that the post is private and viewable only by those notified of the post. However, by default all group members may view posted business information. Once certain business information has been posted as private, access rights to this information can not be altered after posting. Referring again to FIG. 1, the method of communication for business advances from block 18 to block 20.

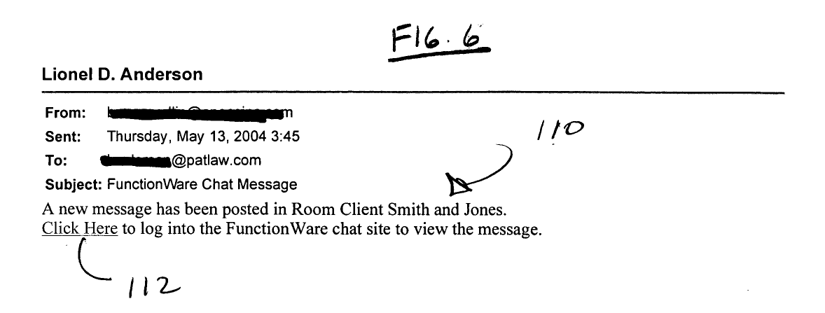

At block 20, members are automatically notified via email that new business communications are being conducted or a question has been asked of that group member therein and that when the group member is available, he or she should log into the chat room as soon as possible to get the up to date information or to reply to the question. As illustrated in FIG. 6, an email message 110 notifies all or a portion of the group members to log into the chat room where new communications are being conducted. When the group member is available to retrieve the email it identifies the name of the room and also provides an electronic link 112 that allows the group member to access the identified chat room when clicked. If the group member has access to multiple rooms, then an email will be sent for each room new communications are being conducted.

Still other user features may be made available which illustratively include a notes section whereby a user is given the ability to type something down which can be stored and retrieved for future reference during a communication session with other members of the group. This is a private area for the group member wherein the next time the group member logs into the chat room, he or she may refer back to the previously recorded notes as a reminder of what was discussed or what should have been accomplished since the group's last discussion.

Another important feature is the facilitation of organization of business information being conducted in the virtual chat rooms. Business information may be stored in a plurality of fashions or formats that can be retrieved at some future time as desired. Illustratively, information may be stored by date and time, by chat room, by project, or the like. Accordingly, storing business information in this fashion provides a form of indexing or organization that makes retrieval at future times more efficient and convenient. Still further, as part of the menu bar 103 options the user may be provided a link to the other rooms he or she has access to which makes communication between groups and group members more efficient. A user may also be allowed to send and receive e-mail to and from users outside of his or her group as desired while still communicating with group members.

From the foregoing description, the present invention provides an inventive method for businesses to communicate with their associates, employees and business partners in a virtual communication environment. The users of the present invention are provided with the ability to view reports and surf the Internet while keeping their communication tools on the same screen for communicating with their respective groups. The foregoing description of the inventive method for communicating is merely illustrative and other embodiments of this invention may become apparent to those skilled in the art. Accordingly, it is understood that various changes to the general concept and features of the invention may be resorted to without departing from the spirit of the invention described herein.

We claim:

1. An Internet enabled communication method for business comprising the steps of:
creating at least one virtual chat room;
designating group members that will have access to the at least one virtual chat room;
providing an interface to the designated group members in the form of a split screen, a first portion of the split screen provides the designated group members Internet access, a second portion of the split screen provides for display and access to business communications being conducted in the at least one virtual chat room;
providing the designated group members access to stored business information that can be viewed in the first portion of the split screen while simultaneously conducting business communications in the second portion of the split screen; and
automatically notifying via email all or a portion of the designated group members that business communications are being conducted in the at least one virtual chat room.

2. The communication method of claim 1 wherein the step of creating at least one virtual room further includes providing access to a service provider's website.

3. The communication method of claim 2 further comprising the step of designating an administrator for the at least one virtual room.

4. The communication method of claim 1 further comprising the step of allowing messages to be posted in the at least one virtual chat room which are only accessible by a predetermined portion of the designated group members.

5. The communication method of claim 1 further comprising the step of allowing the designated group members to make and store notes while in the at least one virtual chat room.

6. The communication method of claim 1 wherein the step of automatically notifying further comprises providing an electronic link in the email that accesses the at least one virtual chat room when clicked.

7. The communication method of claim 1 further including the step of allowing designated group members to access at least one other virtual chat room from a first virtual chat room.
